(19) United States
(12) Patent Application Publication
(10) Pub. No.: US 2022/0070128 A1
(43) Pub. Date: Mar. 3, 2022

(54) INFORMATION PROCESSING APPARATUS AND NON-TRANSITORY COMPUTER READABLE MEDIUM

(71) Applicant: FUJIFILM BUSINESS INNOVATION CORP., Tokyo (JP)

(72) Inventor: Tatsuya KOBAYASHI, Kanagawa (JP)

(73) Assignee: FUJIFILM BUSINESS INNOVATION CORP., Tokyo (JP)

(21) Appl. No.: 17/164,048

(22) Filed: Feb. 1, 2021

(30) Foreign Application Priority Data
Aug. 25, 2020 (JP) 2020-141993

(51) Int. Cl. H04L 12/58

(52) U.S. Cl. CPC H04L 51/30

(57) ABSTRACT

An information processing apparatus includes a processor configured to receive communications that are transmitted or received, perform inspection regarding conformity in a specification of each of the received communications, rectify a communication among the communications to bring the communication into the conformity in the specification, depending on an inspection result of the inspection of the communication, and transmit the rectified communication to a destination of the rectified communication.

### CROSS-REFERENCE TO RELATED APPLICATIONS

This application is based on and claims priority under 35 USC 119 from Japanese Patent Application No. 2020-141993 filed Aug. 25, 2020.

### BACKGROUND

### (i) Technical Field

The present disclosure relates to an information processing apparatus and a non-transitory computer readable medium.

### (ii) Related Art

Some communication systems are provided with a mechanism for determining whether the contents of individual communication are appropriate and for correcting a content needed to be corrected. For example, e-mail systems use technology for determining the text of an e-mail and then correcting the text as necessary.

Japanese Unexamined Patent Application Publication No. 2016-4560 discloses a mail correction support system including a correction support function and a correction support database. The correction support function has a function of storing and performing learning on pieces of information including an error in the contents of a request mail in mail exchange including transmission of a request mail and reception of a reply mail. The information also includes the correction of the error. The correction support function also has a transmission function implemented when the request mail is transmitted. The transmission function generates a corrected request mail in which the error in the contents of the request mail is corrected on the basis of the learning and transmits the corrected request mail to an external service.

Japanese Unexamined Patent Application Publication No. 2015-194928 discloses an automatic e-mail correction support system including an automatic correction support database and an automatic correction support server. The automatic correction support database stores correction history information for automatically correcting a minor error in the text of a request mail. The automatic correction support server refers to correction information and thereby automatically corrects a minor error by using a minor error learning function, an automatic request-mail correction proposal function, and a change-information reflection function.

### SUMMARY

Generally, specifications to be satisfied in individual communications have been stipulated for communication systems. It is thus conceivable that whether not only the content of a communication as described above but also individual communications satisfy the stipulated specifications is determined.

However, some communication systems are operated flexibly to some extent regarding specification satisfaction, and thus a communication server in such communication systems permits even an individual communication not strictly satisfying the stipulated specifications. For example, for e-mail systems, transmission and reception protocols are strictly stipulated in the request for comments (RFC); however, there are mail servers (such as a SMTP server and a POP server) and mail clients (software) that permit transmission and reception of an e-mail not conforming to the RFC.

In addition, it is possible that there is a communication system that permits the presence of a communication server or the like postulating the observance of standard specifications and requiring the observance of a uniquely stipulated rule in addition to the standard specifications. For example, there is an e-mail system that has a mail server requiring the encryption of the body of an e-mail by a specific encryption method from a security viewpoint, separately from the conformity to the RFC specifications. Accordingly, it is possible that in one communication system conforming to standard specifications, an individual communication is permitted or not permitted depending on the communication server.

Aspects of non-limiting embodiments of the present disclosure relate to enabling a communication to be continued in accordance with communication protocols respectively used by a sender and a receiver as compared to a case where an error is simply returned in response to a communication violating any of the communication protocols.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to receive communications that are transmitted or received, perform inspection regarding conformity in a specification of each of the received communications, rectify a communication among the communications to bring the communication into the conformity in the specification, depending on an inspection result of the inspection of the communication, and transmit the rectified communication to a destination of the rectified communication.

### BRIEF DESCRIPTION OF THE DRAWINGS

An exemplary embodiment of the present disclosure will be described in detail based on the following figures, wherein:

FIG. 1 is a view illustrating the overall configuration of a communication system to which this exemplary embodiment is applied;

FIG. 2 is a view illustrating the functional configuration of a relay device;

FIG. 3 is a view illustrating an example hardware configuration of a computer implementing the relay device;

FIG. 4 is a view illustrating a model generation method;

FIG. 5 is a view illustrating how an e-mail is inspected and rectified on the basis of a model;

FIG. 6 is a view illustrating an example report screen for an administrator;

FIG. 7 is a view illustrating an example report screen for a user at a transmission source; and

FIG. 8 is a view illustrating the functional configuration of a terminal apparatus having a function of executing an inspection and rectification process on e-mails.

### DETAILED DESCRIPTION

Hereinafter, an exemplary embodiment of the present disclosure will be described in detail with reference to the attached drawings.

### Configuration of Target Apparatuses

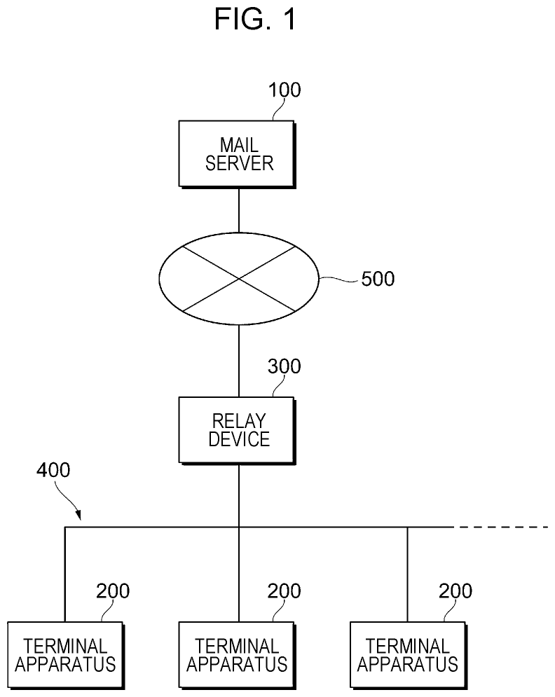

FIG. 1 is a view illustrating the overall configuration of a communication system to which this exemplary embodiment is applied. This exemplary embodiment is applied to various communication systems. An example in which this exemplary embodiment is applied to an e-mail system taken as an example of the communication system will herein be described. The e-mail system illustrated in FIG. 1 includes a mail server 100, terminal apparatuses 200, and a relay device 300. The relay device 300 relays e-mails transmitted and received by the terminal apparatuses 200. The terminal apparatuses 200 and the relay device 300 are connected via a network 400. The network 400 is, for example, a local area network (LAN). The mail server 100 and the relay device 300 are connected via a network 500. The network 500 is, for example, the Internet. The communication networks as the network 400 and the network 500 may be a wired network or a wireless network.

The mail server 100 is a server (SMTP server) that receives an e-mail transmitted from one of the terminal apparatuses 200 and transmits the e-mail to the destination thereof. The mail server 100 has a function of inspecting the format and the security of the e-mail received from the terminal apparatus 200. The mail server 100 rejects, for example, the receiving of an e-mail determined to be invalid in the inspection. The mail server 100 is implemented by a computer serving as a server connected to, for example, the network 500.

Each terminal apparatus 200 has a function of generating (editing) an e-mail and a function of transmitting the generated e-mail. The terminal apparatus 200 also has functions of receiving, from the mail server 100, an e-mail addressed to the terminal apparatus 200 and viewing the received e-mail. The terminal apparatus 200 is implemented by an information processing apparatus such as a personal computer, a tablet terminal, a smartphone, or a mobile phone.

The relay device 300 receives an e-mail transmitted from one of the terminal apparatuses 200, holds the e-mail temporarily, and inspects the held e-mail. The relay device 300 transmits an e-mail determined to be appropriate in the inspection to the mail server 100. The relay device 300 rectifies an e-mail determined to be inappropriate in the inspection and transmits the e-mail to the mail server 100. The relay device 300 also receives an e-mail transmitted from the mail server 100 in response to a request for receiving the e-mail from one of the terminal apparatuses 200 and transmits the e-mail to the terminal apparatus 200 having made the reception request.

### Functional Configuration of Relay Device 300

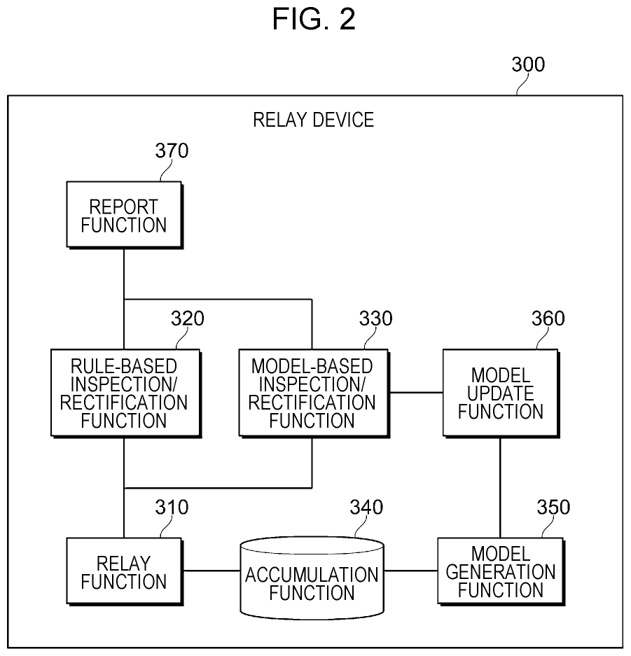

FIG. 2 is a view illustrating the functional configuration of the relay device 300. The relay device 300 includes a relay function 310, a rule-based inspection/rectification function 320, a model-based inspection/rectification function 330, an accumulation function 340, a model generation function 350, a model update function 360, and a report function 370.

The relay function 310 is a function of receiving an e-mail transmitted from one of the terminal apparatuses 200, holding the e-mail temporarily, and then transmitting the e-mail to the mail server 100 and is also a function of receiving an e-mail transmitted from the mail server 100 and transmitting the e-mail to one of the terminal apparatuses 200. Before transmitting the e-mail to the mail server 100, the relay device 300 delivers the received and held e-mail for inspection to the rule-based inspection/rectification function 320 and the model-based inspection/rectification function 330.

The rule-based inspection/rectification function 320 is a function of executing an inspection and rectification process based on a predetermined rule (hereinafter, referred to as an inspection rule) on an e-mail. Specifically, the rule-based inspection/rectification function 320 inspects whether the specifications of the e-mail are valid on the basis of the inspection rule. The specifications of the e-mail to be inspected include a communication protocol. The rule-based inspection/rectification function 320 rectifies the specifications of an e-mail determined to be invalid to valid specifications. For the e-mail inspection, for example, the RFC specifications for e-mail may be used as the inspection rule.

The model-based inspection/rectification function 330 is a function of executing an inspection and rectification process based on a model on an e-mail. Specifically, the model-based inspection/rectification function 330 inspects whether the e-mail conforms to a model. The model-based inspection/rectification function 330 rectifies the specifications of an e-mail determined not to conform to the model to bring the specifications into conformity to the model. The model is generated by extracting characteristics of e-mails succeeding in transmission and reception among e-mails relayed in the past by the relay device 300. To generate the model, both of e-mails succeeding in transmission and reception and e-mails failing in transmission and reception are used. A model based on the e-mails succeeding in transmission and reception (hereinafter, referred to as a success model) and a model based on the e-mails failing in transmission and reception (hereinafter, referred to as a failure model) may be generated separately. In this case, if an e-mail does not conform to the success model or conforms to the failure model in the inspection, the model-based inspection/rectification function 330 rectifies the e-mail to bring the e-mail into conformity to the success model. In addition, models may be respectively generated on the basis of the terminal apparatus 200 serving as a transmission source, a destination, the mail server 100, and the like. A model generation method is described later.

The accumulation function 340 is a function of accumulating e-mails relayed by the relay device 300. Both of the e-mails succeeding in transmission and reception and the e-mails failing in transmission and reception are accumulated. The e-mails accumulated by the accumulation function 340 are used to generate a model used for the inspection and rectification process by the model-based inspection/rectification function 330.

The model generation function 350 is a function of generating a model used for the inspection and rectification process by the model-based inspection/rectification function 330. On the basis of the e-mails accumulated in the accumulation function 340, the model generation function 350 learns characteristics common to the e-mails succeeding in transmission and reception and characteristics common to the e-mails failing in transmission and reception. The model generation function 350 generates a model having the former characteristics and not having the latter characteristics. In the case where the success model and the failure model are generated separately, the model generation function 350 generates the success model by learning the characteristics common to the e-mails succeeding in transmission and reception and generates the failure model by learning the characteristics common to the e-mails failing in transmission and reception. After generating the model, the model generation function 350 updates the model generated by using the e-mails accumulated in the accumulation function 340. Accordingly, the most recent specifications of the e-mails actually transmitted and received (instances) are reflected in the model. It is thereby possible to respond to specification change or the like in a destination or the mail server 100. Note that if a trained model is used to execute the inspection and rectification process on e-mails and is not updated on the basis of the e-mails transmitted and received after the inspection and rectification process, the trained model only has to be held. In such a case, the relay device 300 does not necessarily have to have the accumulation function 340 for accumulating the relayed e-mails and the model generation function 350.

The model update function 360 is a function of updating the model used by the model-based inspection/rectification function 330 if the inspection rule is changed. The model is updated to conform to the changed inspection rule. Every time the relay device 300 relays an e-mail, the learning based on the e-mails accumulated in the accumulation function 340 is reflected in the model used by the model-based inspection/rectification function 330, and the model is updated. If an individual specification change or the like in the mail server 100 or the destination of communication leads to the necessity for a change to the model, repeatedly performing communications causes the model to gradually adapt to the specification change or the like. However, if a change to the inspection rule leads to an inappropriate inspection and rectification process by the model-based inspection/rectification function 330, the inspection and rectification process needs to promptly follow the change in the inspection rule. The case where the inspection and rectification process by the model-based inspection/rectification function 330 is inappropriate is, for example, a case where all of communications conforming to the model are determined to be invalid on the basis of the inspection rule. The model update function 360 thus updates the model to bring the communications into conformity to the inspection rule.

The report function 370 reports the results of the inspection and the rectification performed by the rule-based inspection/rectification function 320 and the model-based inspection/rectification function 330 to a communication administrator or a user at the transmission source terminal apparatus 200. The report function 370 may be configured to, in response to reporting to the communication administrator or the user at the transmission source, receive designation by the communication administrator or the user at the transmission source as the reporting target, and then execute a rectification process and a transmission process. The details of conditions for the reporting, the content of the report, the designation by the communication administrator or the transmission source, and operations in response to receiving the designation, and the like will be described later.

### Hardware Configuration of Relay Device 300

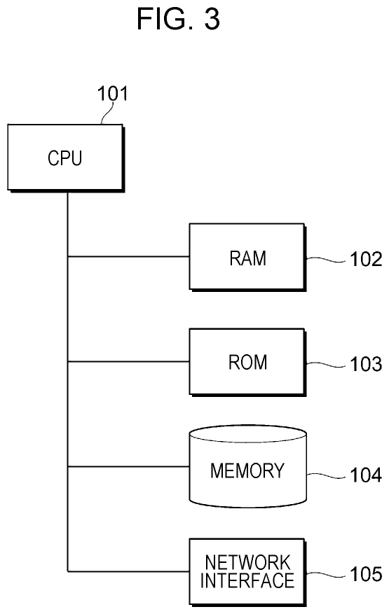

The relay device 300 is implemented by a computer. FIG. 3 is a view illustrating an example hardware configuration of the computer implementing the relay device 300. The computer implementing the relay device 300 includes a central processing unit (CPU) 101 that is an arithmetic unit, a random access memory (RAM) 102 that is a memory, a read only memory (ROM) 103, a memory 104, and a network interface 105. The RAM 102 is a main memory and is used as a work memory for the CPU 101 to perform arithmetic processing. The ROM 103 holds programs and data such as set values prepared in advance. The CPU 101 is capable of reading out a program or data directly from the ROM 103 and executing a process. The memory 104 is a storage for programs and data. The memory 104 stores the programs, and the CPU 101 loads a program stored in the memory 104 into the main memory and runs the program. The memory 104 stores results of processing by the CPU 101. As the memory 104, for example, a magnetic disk device, a solid state drive (SSD), or the like is used. The network interface 105 is an interface for connecting to the network 400 and the network 500.

When the relay device 300 is implemented by the computer illustrated in FIG. 3, the relay function 310, the rule-based inspection/rectification function 320, the model-based inspection/rectification function 330, the model generation function 350, the model update function 360, and the report function 370 are implemented, for example, in such a manner that the CPU 101 runs a program. The accumulation function 340 is implemented by the memory 104.

### Relationship Between Rule-Based Rectification and Model-Based Rectification

Communication systems for which a rule to be observed such as the RFC for e-mail is stipulated are originally required to observe a rule stipulating specifications for individual communications. However, some communication systems permit an individual communication not strictly observing the stipulated rule. For example, although an e-mail address of an e-mail causes an error when being transmitted from a personal computer via a provider, the e-mail may be transmitted and received between smartphones or mobile phones on some occasions. This occurs because the e-mail address does not conform to the RFC specifications but is permitted in an e-mail service for specific smartphones or specific mobile phones. In this case, in the rule-based inspection and rectification process, the e-mail address is necessarily to undergo the rectification process. In contrast, in the model-based inspection and rectification process, the e-mail may be transmitted and received between the specific smartphones or the specific mobile phones that permit an e-mail address not conforming to the RFC, without executing the rectification process on the e-mail address. On the contrary, if the e-mail address used in transmission and reception between the specific smartphones or the specific mobile phones undergoes the rule-based inspection and rectification process, it is possible to avoid the occurrence of an error even in the communication from the personal computer via the provider.

In addition, there is a communication system that permits the presence of a communication server or the like that requires the observance of an independently stipulated rule in addition to standard specifications. For example, an e-mail system has a mail server that requires encryption of the body of an e-mail by a specific encryption method separately from the conformity to the RFC specifications. In such cases, in the rule-based inspection and rectification process, it is not possible to execute an individually required process such as the encryption, and thus even an e-mail undergoing the rectification process has an error in transmission or reception. In contrast, in the model-based inspection and rectification process, a model is generated by using e-mails having undergone the individually required process and succeeding in communication. Accordingly, rectifying a target e-mail to bring the e-mail into conformity to the model enables transmission and reception.

As described above, the rule-based inspection and rectification process and the model-based inspection and rectification process partially overlap with each other in the application range but are different from each other. Both of the rule-based inspection/rectification function 320 and the model-based inspection/rectification function 330 may thus be provided to execute the respective inspection and rectification processes. In addition, depending on the operation of the relay device 300, only one of the rule-based inspection/rectification function 320 and the model-based inspection/rectification function 330 may be provided, and the inspection and rectification process to be executed by the other may be executed by using the function of the relay device 300.

### Generating Model

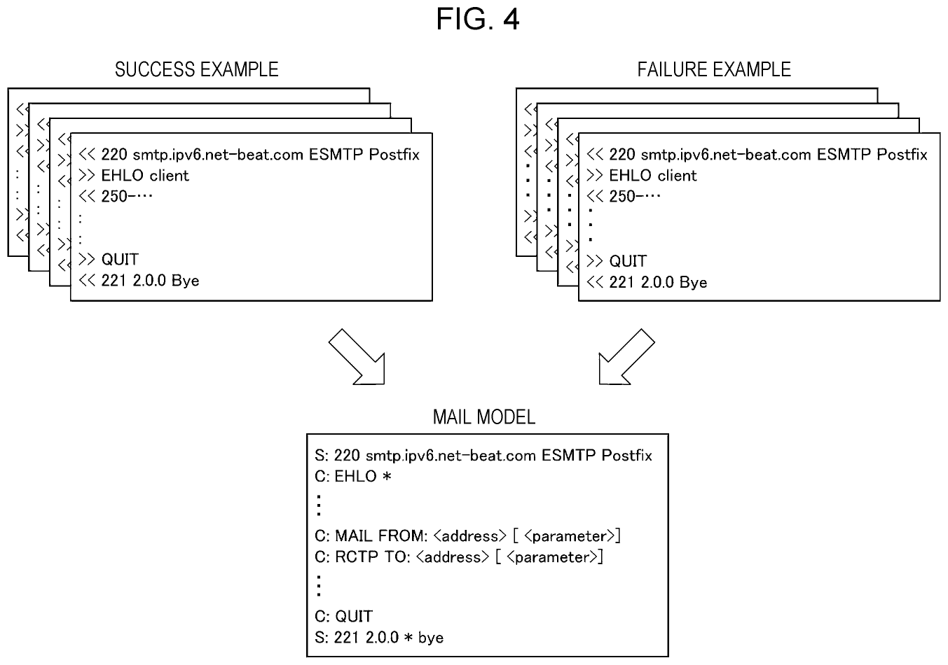

FIG. 4 is a view illustrating the model generation method. The relay function 310 collects e-mails accumulated by the accumulation function 340 by using the model generation function 350 in such a manner as to divide the e-mails as e-mails succeeding in transmission and reception (Success example in FIG. 4) and e-mails failing in transmission and reception (Failure example in FIG. 4). The relay function 310 extracts characteristics common to the e-mails in the success example and characteristics common to the e-mails in the failure example and thereby generates a model (Mail model in FIG. 4). Conceivable characteristics extracted from the e-mails are characteristics of a character string in a specific item, combination of contents of items, and the like; however, actually, contents concretely obtained from the collected e-mails in the success example and the failure example are extracted. To extract the characteristics, a machine learning method such as deep learning may be used. The machine learning method used to generate a model may be any of various existing methods applicable in extracting the characteristics of the e-mails in the success example and the failure example.

FIG. 4 illustrates e-mail protocols in the success example and the failure example. Characteristic parts in the success example and the failure example are not illustrated. The model has examples of the protocols including the characteristics items extracted from the success example. In the example illustrated in FIG. 4, the description in the first line “S: 220 smtp.ipv6.net-beat.com ESMTP Postfix” is a message transmitted from the mail server 100 (denoted by S in the description) to the requesting terminal apparatus 200 and reporting that connection to the mail server 100 has been established. The description in the second line “C: EHLO *” is a HELO command transmitted from one of the terminal apparatuses 200 (C in the description) to the mail server 100. The description in the middle “C: MAIL FROM: <address>[<parameter>]” is sender information transmitted from the terminal apparatus 200 (C) to the mail server 100. The description in the next line “C: RCTP TO: <address>[<parameter>]” is destination information transmitted from the terminal apparatus 200 (C) to the mail server 100. The description in the second last line “C: QUIT” is a Quit command (termination information) transmitted from the terminal apparatus 200 (C) to the mail server 100. The description in the last line “S: 221 2.0.0 bye” is a report indicating that an e-mail transmitted from the terminal apparatus 200 and then transmitted from the mail server 100 (S) to a different one of the terminal apparatuses 200 has been received (transmission success).

The model illustrated in FIG. 4 reads that the conformity of the sender information transmitted from the terminal apparatus 200 (C) to the mail server 100 to the format “<address>[<parameter>]” and the conformity of the destination information transmitted from the terminal apparatus 200 (C) to the mail server 100 to the format “<address>[<parameter>]” are conditions for being determined as a valid e-mail by the model-based inspection/rectification function 330.

### E-Mail Inspection and Correction Based on Model

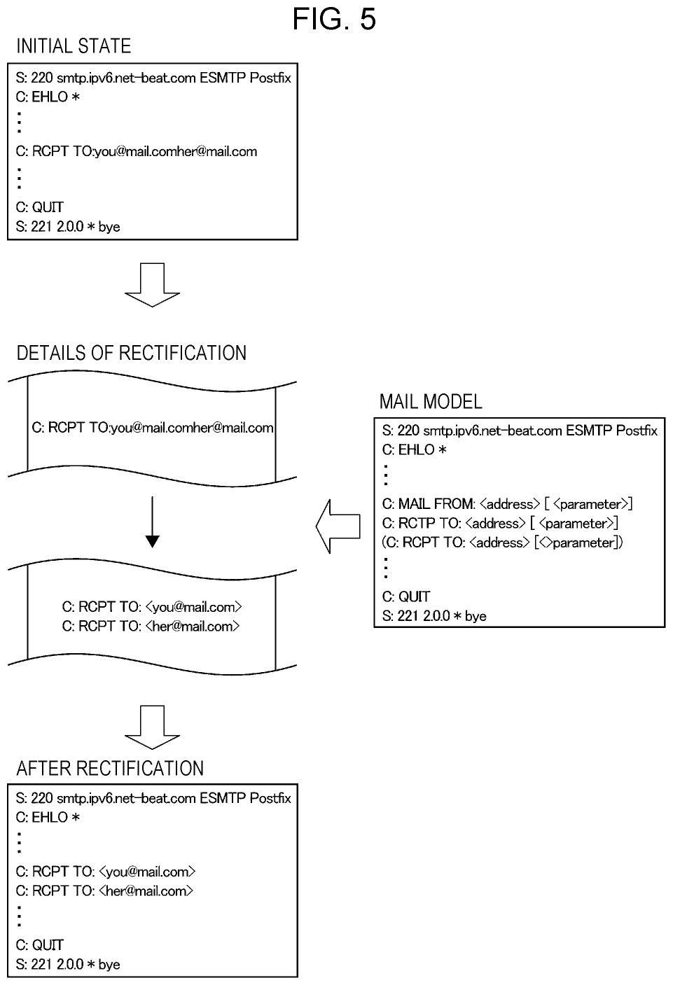

FIG. 5 is a view illustrating how an e-mail is inspected and rectified on the basis of the model. In the example illustrated in FIG. 5, how an e-mail in a rectified format (After rectification in FIG. 5) is obtained from an e-mail transmitted from the terminal apparatus 200 and received by the relay device 300 (Initial state in FIG. 5) by executing a rectification process based on the model (Mail model in FIG. 5).

The model illustrated in FIG. 5 requires an e-mail directed to multiple addresses to have respective pieces of destination information in the format “<address>[<parameter>]”, whereas the e-mail in the initial state has one piece of destination information having combination of the two addresses “you@mail.com” and “her@mail.com”. In addition, each address is not interposed between the broken brackets “< >”. The description in these manners violates the format required by the model. The relay device 300 thus rectifies the two addresses to the individual pieces of destination information “<you@mail.com>” and “<her@mail.com>” to bring the addresses into conformity to the model. The e-mail after the rectification has the format in which the descriptions of the destination information conform to the model.

### Applying Inspection and Rectification Process

Each of the rule-based inspection/rectification function 320 and the model-based inspection/rectification function 330 basically executes the inspection and rectification process on all the e-mails relayed by the relay device 300. However, executing the inspection and rectification process on a large number of e-mails leads to an increase in load on the relay device 300. Hence, if a specific condition is satisfied, the e-mail inspection may be omitted. For example, if a condition set in advance regarding at least one of the transmission source or the destination of an e-mail is satisfied, the inspection of communication may be omitted.

In a specific example, the inspection may be omitted on condition that a communication from a specific transmission source to a specific destination succeeds a predetermined number of times or more without being rectified. This is because in this case, communication from the same transmission source as before to the same destination as before is considered to have a high probability of success also in the future. In this case, for example, on condition that a predetermined period has elapsed since the omission of the inspection, the communication from the same transmission source to the same destination may be inspected again. In addition, on condition that the communication has been performed a predetermined number of times since the omission of the inspection, the communication from the same transmission source to the same destination may be inspected again. Since it is possible that specifications of the mail server 100 or the terminal apparatus 200 are changed before the predetermined period elapses or before the communication is performed the predetermined number of times, the inspection is performed again to discuss the necessity for the rectification process.

If simultaneous communications (multicast or broadcast) are performed from one communication source to multiple destinations, the inspection of only a portion of the multiple communications may be performed, and the inspection of one or more remaining communications may be omitted. This is because the communications are performed on the basis of the same specifications, and thus executing the inspection on all the communications is considered to be redundant. However, if the destination terminal apparatus 200 or the destination mail server 100 has different specifications, some communications among communications even with the same specifications succeed, and other communications fail, depending on the destination. A conceivable way of addressing this is performing the inspection of communications to a small number of destinations (such destinations that are known to have different specifications) and omitting the inspection of communications to the other destinations.

In addition, in response to success of a communication from a specific transmission source to a specific destination without undergoing the rectification process, the inspection may be omitted in the following case. Specifically, when a communication by a sender who is different from a sender at the transmission source and who has a specific relationship with the transmission source in the specification of the communication is transmitted to the destination, the communication may be omitted. The different sender having the specific relationship with the transmission source may be, for example, a different sender who is a member registered in a mailing list including the transmission source and performs a communication using the mailing list. In addition, a user directed as a cc or bcc destination in the communication resulting in success may be the different sender having the specific relationship. The user specifically serving as the different sender having the specific relationship with the transmission source may be set individually on the basis of the operation or the like of the communication system or the relay device 300.

### Reporting Inspection Result and Rectification Result

In the description above, if an inspection target e-mail inspected by each of the rule-based inspection/rectification function 320 and the model-based inspection/rectification function 330 does not conform to the rule or the model and needs to undergo the rectification process, the rectification process is executed immediately. In contrast, the relay device 300 may be configured to report the inspection result and the rectification result to the administrator or a user at the e-mail transmission source and to transmit the e-mail in response to receiving designation by the administrator or the user at the transmission source. Note that the report to the user at the transmission source is transmitted to the terminal apparatus 200 used by the user. The terminal apparatus 200 of the user receiving the report displays a report screen indicating the content of the report. The report screen also serves as a user interface (UI) for receiving the designation by the user. The user performs the designation by operating the report screen. The administrator is one of the users of the terminal apparatuses 200. The report to the administrator is thus transmitted to the terminal apparatus 200 used by the administrator. The terminal apparatus 200 of the administrator receiving the report displays the report screen indicating the content of the report. The administrator performs the designation by operating the report screen.

Conceivable reports to the administrator and the user at the transmission source are, for example, a report of only the inspection result and a report of the inspection result and the rectification result. In the case of reporting only the inspection result, the administrator or the user at the transmission source who has received the report confirms the inspection result and designates whether to execute the rectification process. In the case of reporting the inspection result and the rectification result, the administrator or the user at the transmission source who has received the report confirms the inspection result and the rectification result and designates whether to approve the rectification process.

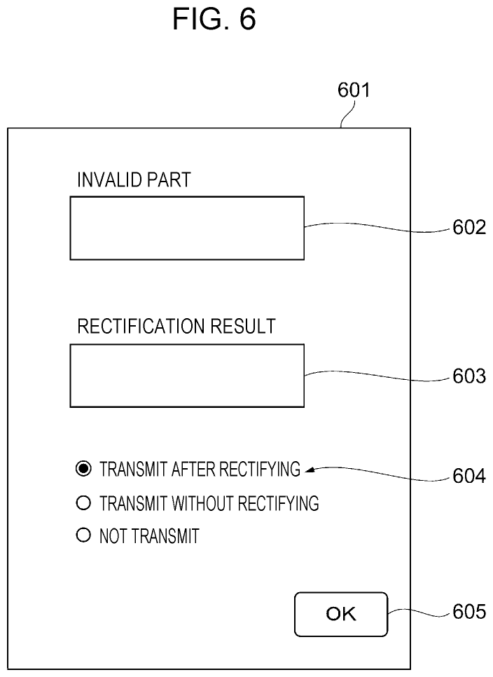

FIG. 6 is a view illustrating an example report screen for the administrator. A report screen 601 illustrated in FIG. 6 includes an inspection result display 602, a rectification result display 603, a designation selection unit 604, and an enter button 605.

The inspection result display 602 displays the result of the inspection by the rule-based inspection/rectification function 320 or the model-based inspection/rectification function 330 and an invalid part detected in the inspection target e-mail. If an invalid part is not detected, a message indicating the absence of an invalid part as the inspection result may be displayed.

The rectification result display 603 displays the result of rectifying the detected invalid part of the e-mail. If the inspection results in no invalid part detection, the rectification process is not executed. The rectification result display 603 thus displays nothing.

The designation selection unit 604 receives an operation for selecting designation from the administrator who looks at the report screen. In the example illustrated in FIG. 6, one of three types of designation “Transmit after rectifying”, “Transmit without rectifying”, and “Not transmit” is selectable. The administrator selects whether to rectify the e-mail and whether to transmit (relay) the target e-mail to the destination. The enter button 605 (OK in FIG. 6) is a button object for entering the designation selected by using the designation selection unit 604 and for transmitting the designation to the relay device 300.

Note that the report screen 601 illustrated in FIG. 6 is merely an example of the report from the relay device 300 to the administrator, and how the reporting is performed is not limited to the displaying by the report screen 601 illustrated in FIG. 6. For example, the report screen 601 illustrated in FIG. 6 displays the inspection result and the rectification result but may be configured to display only the inspection result. In this case, the administrator refers to the invalid part displayed in the inspection result and determines whether the rectification process is needed. If the inspection result and the rectification result are displayed as illustrated in FIG. 6, the administrator confirms what the rectification is like by referring to the rectification result and thereby may select the designation to be given to the relay device 300. The report screen 601 may be configured to, in response to detecting an invalid part, display only the result of the rectification process executed on the detected invalid part without displaying the inspection result. In this case, the administrator selects designation to be given to the relay device 300 on the basis of only the displayed rectification result. The content of the designation selected by using the designation selection unit 604 is not limited to the content illustrated in FIG. 6.

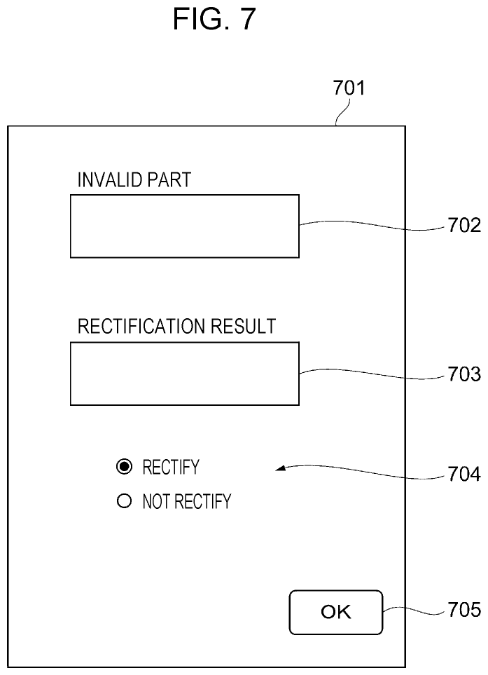

FIG. 7 is a view illustrating an example report screen for the user at the transmission source. A report screen 701 illustrated in FIG. 7 includes an inspection result display 702, a rectification result display 703, a designation selection unit 704, and an enter button 705.

The inspection result display 702 displays the result of the inspection by the rule-based inspection/rectification function 320 or the model-based inspection/rectification function 330 and an invalid part detected in the inspection target e-mail. If an invalid part is not detected, a message indicating no invalid part as the inspection result may be displayed.

The rectification result display 703 displays the result of rectifying the detected invalid part of the e-mail. If the inspection results in no invalid part detection, the rectification process is not executed. The rectification result display 703 thus displays nothing.

The designation selection unit 704 receives an operation for selecting designation by the user at the transmission source who looks at the report screen. In the example illustrated in FIG. 7, one of two types of designation “Rectify” and “Not rectify” is selectable. The relay device 300 receives (relays) an e-mail after the e-mail is transmitted from one of the terminal apparatuses 200 as the transmission source of the e-mail. In other words, the transmission has been designated in the transmission source terminal apparatus 200. Accordingly, unlike the report to the administrator, only whether to rectify is designated in this case and whether to transmit is not designated. The enter button 705 (OK in FIG. 7) is a button object for entering the designation selected by using the designation selection unit 704 and transmits the designation to the relay device 300.

Note that the report screen 701 illustrated in FIG. 7 is merely an example of the report from the relay device 300 to the transmission source terminal apparatus 200, and how the reporting is performed is not limited to the displaying by the report screen 701 illustrated in FIG. 7. For example, the report screen 701 illustrated in FIG. 7 displays the inspection result and the rectification result but may be configured to display only the inspection result. The content of the designation selected by using the designation selection unit 704 is not limited to the content illustrated in FIG. 7.

### Other System Configurations

In the example configuration described with reference to FIGS. 1 and 2, the relay device 300 for communication executes the inspection and rectification process on a relay target communication. The specific configuration of this exemplary embodiment is not limited to the example configuration. For example, a configuration in which the terminal apparatus 200 that is the transmission source executes the inspection and rectification process at the time of the transmission may be used.

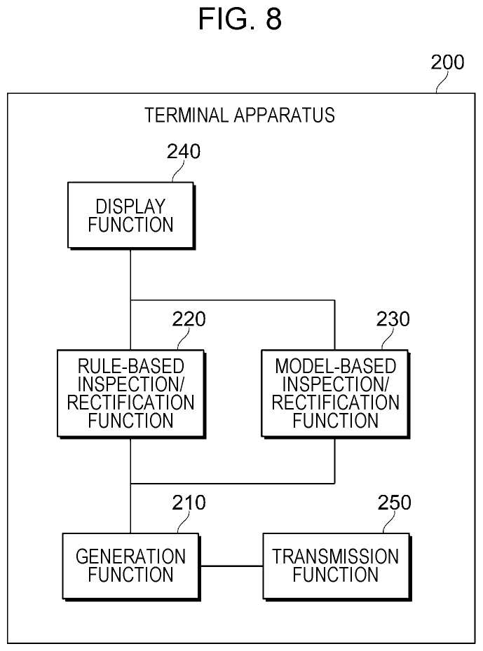

FIG. 8 is a view illustrating the functional configuration of a terminal apparatus 200 having the function of executing the inspection and rectification process on e-mails. The terminal apparatus 200 illustrated in FIG. 8 includes a generation function 210, a rule-based inspection/rectification function 220, a model-based inspection/rectification function 230, a display function 240, and a transmission function 250.

The generation function 210 is the function of generating (editing) an e-mail to be transmitted. The rule-based inspection/rectification function 220 is the same as the rule-based inspection/rectification function 320 of the relay device 300 illustrated in FIG. 2 and is the function of executing the inspection and rectification process based on the inspection rule on an e-mail generated by the generation function 210. The model-based inspection/rectification function 230 is the same as the model-based inspection/rectification function 330 of the relay device 300 illustrated in FIG. 2 and is the function of executing the inspection and rectification process based on the model on an e-mail generated by the generation function 210. The display function 240 is a function of displaying, on the display device, an e-mail generated by the generation function 210 and the result of the inspection by the rule-based inspection/rectification function 220 or the model-based inspection/rectification function 230. The user may perform editing of the body of an e-mail with reference to the display by the display function 240, confirming the result of the inspection by the rule-based inspection/rectification function 220 or the model-based inspection/rectification function 230, and the like. The transmission function 250 is a function of transmitting an e-mail generated by the generation function 210 to a designated destination.

In response to generating an e-mail in the terminal apparatus 200 configured as illustrated in FIG. 8, the rule-based inspection/rectification function 220 and the model-based inspection/rectification function 230 inspect the generated e-mail. The display function 240 then displays the inspection result and thereby reports the result to the user. The inspection result is displayed by using, for example, the display screen such as the report screen 601 illustrated in FIG. 6. As mentioned with reference to the report screen 601, the result of the rectification process may also be displayed together with the inspection result. This enables the user to confirm the inspection result and the rectification result and to decide whether to approve the rectification process.

The exemplary embodiment of the present disclosure has heretofore been described; however, the technical scope of the present disclosure is not limited to that in the exemplary embodiment above. For example, in the exemplary embodiment above, the example configuration in which the relay device 300 executes the inspection and rectification process on an e-mail and the example configuration in which the terminal apparatus 200 executes the inspection and rectification process on an e-mail have been described. In another example, the mail server 100 may be configured to execute the inspection and rectification process on an e-mail received from the terminal apparatus 200.

In the exemplary embodiment above, in response to receiving an e-mail to be relayed from the terminal apparatus 200, the relay device 300 executes the inspection and rectification process on the received e-mail before transmitting the e-mail to the mail server 100. In contrast, the relay device 300 may be configured as follows. The relay device 300 holds the received e-mail and also transmits the e-mail to the mail server 100. If an error occurs on the destination, the relay device 300 executes the inspection and rectification process. Neither the inspection nor the rectification process is thereby executed on an e-mail not requiring the rectification process, and thus an increase in time taken for the relay may be reduced. In addition, assume a case where an e-mail is determined to require the rectification process as the result of the inspection based on the inspection rule or the model but actually does not result in an error on the basis of the specifications of the mail server 100 or the destination. In this case, the rectification process executed unnecessarily on the e-mail may be avoided.

In this exemplary embodiment, the example in which this exemplary embodiment is applied to the e-mail system taken as an example of the communication system has been described. However, this exemplary embodiment may be widely applied to such a communication system that is operated flexibly regarding standard-specification satisfaction and that permits even an individual communication not strictly satisfying the stipulated specifications. In addition, various modifications and configuration replacement are included in the present disclosure without departing from the scope of the technical spirit of the present disclosure.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to
receive communications that are transmitted or received,
perform inspection regarding conformity in a specification of each of the received communications,
rectify a communication among the communications to bring the communication into the conformity in the specification, depending on an inspection result of the inspection of the communication, and
transmit the rectified communication to a destination of the rectified communication.

2. The information processing apparatus according to claim 1,
wherein the processor is configured to
perform the inspection of each received communication on a basis of a communication model generated on a basis of past communications and
rectify the communication to bring the communication into conformity to the communication model.

3. The information processing apparatus according to claim 2,
wherein the processor is configured to
record at least one communication among the received communications and success or failure information of the at least one communication and
generate the communication model by using the at least one recorded communication and the success or failure information.

4. The information processing apparatus according to claim 3,
wherein the processor is configured to generate the communication model by performing machine learning using, as training data, a success communication that succeeds among the communications, a failure communication that fails among the communications, and the success or failure information of each of the success communication and the failure communication.

5. The information processing apparatus according to claim 2,
wherein the processor is configured to
perform inspection of whether each received communication conforms to a rule separately from the inspection based on the communication model, the rule being stipulated in advance for the specification and
rectify a communication among the communications to bring the communication into conformity to the rule, depending on a result of the inspection based on the rule.

6. The information processing apparatus according to claim 1,
wherein the processor is configured to, when a communication among the received communications satisfies a condition set in advance regarding at least one of a transmission source or a destination of the communication, omit the inspection of the communication and transmit the communication to the destination of the communication.

7. The information processing apparatus according to claim 6,
wherein the processor is configured to, on condition that a communication from a specific transmission source to a specific destination succeeds a predetermined number of times or more without being rectified regarding the specification, omit the inspection of the communication from the specific transmission source to the specific destination.

8. The information processing apparatus according to claim 7,
wherein the processor is configured to, on condition that a predetermined period has elapsed since the inspection omitted on a basis of combination of the transmission source and the destination, perform the inspection of the communication from the transmission source to the destination.

9. The information processing apparatus according to claim 7,
wherein the processor is configured to, on condition that the communication from the transmission source to the destination has been performed a predetermined number of times since the inspection omitted on a basis of combination of the transmission source and the destination, perform the inspection of the communication from the transmission source to the destination.

10. The information processing apparatus according to claim 6,
wherein the processor is configured to perform the inspection of a portion of a plurality of communications simultaneously performed from one communication source to a plurality of destinations and omit the inspection of one or more remaining communications.

11. The information processing apparatus according to claim 6,
wherein the processor is configured to, in response to success of a communication from a specific transmission source to a specific destination without being rectified regarding the specification, omit the inspection of a communication transmitted to the specific destination by a sender who is different from a sender at the specific transmission source and who has a specific relationship in the specification with the specific transmission source.

12. The information processing apparatus according to claim 1,
wherein the processor is configured to report, to an administrator, at least one of the inspection result regarding the communication among the received communication or a rectification result obtained by rectifying the communication.

13. The information processing apparatus according to claim 12,
wherein the processor is configured to, in response to reporting the at least one of the inspection result or the rectification result to the administrator, transmit the communication to a destination of the communication on condition that permission of the administrator is obtained.

14. The information processing apparatus according to claim 12,
wherein the processor is configured to, in response to reporting the inspection result to the administrator, rectify the communication on condition that designation by the administrator is received.

15. The information processing apparatus according to claim 1,
wherein the processor is configured to report, to a transmission source of a communication among the received communications, at least one of the inspection result regarding the communication or a rectification result obtained by rectifying the communication.

16. The information processing apparatus according to claim 15,
wherein the processor is configured to, in response to reporting the inspection result to the transmission source, rectify the communication on condition that designation by the transmission source is received.

17. A non-transitory computer readable medium storing a program causing a computer to execute a process comprising:
receiving communications addressed to respective destinations that are different from the computer;
performing inspection regarding conformity in a specification of each of the received communications;
rectifying a communication among the communications to bring the communication into the conformity in the specification, depending on a result of the inspection of the communication; and
transmitting the rectified communication to a destination of the rectified communication.

18. An information processing apparatus comprising:
means for receiving communications that are transmitted or received,
means for performing inspection regarding conformity in a specification of each of the received communications,
means for rectifying a communication among the communications to bring the communication into the conformity in the specification, depending on an inspection result of the inspection of the communication, and
means for transmitting the rectified communication to a destination of the rectified communication.
